(19) United States
(12) Patent Application Publication
(10) Pub. No.: US 2021/0386136 A1
(43) Pub. Date: Dec. 16, 2021

(54) ADJUSTABLE FACE MASK

(71) Applicant: Airgill Ltd, Northumberland (GB)

(72) Inventors: Adam Yates, Northumberland (GB); Michael Corcoran, Northumberland (GB); Louis Simon Street, Northumberland (GB)

(21) Appl. No.: 17/348,610

(22) Filed: Jun. 15, 2021

(30) Foreign Application Priority Data
Jun. 16, 2020 (GB) 2009154.2

(51) Int. Cl. A41D 13/11; A62B 23/02

(52) U.S. Cl. CPC A41D 13/1138; A41D 13/1184; A62B 23/02; A41D 13/1161

(57) ABSTRACT

A face mask is provided for filtering a respiratory air flow of a user, the face mask comprising a main body, an external support frame and at least one inlet connector. The main body comprises elastomeric material and is configured to accommodate to facial features of the user. The main body further comprises at least one air inlet opening and at least one air outlet opening. The external support frame supports the main body. The inlet connector extends at least partly through the at least one air inlet of the main body and a corresponding air inlet of the support frame and comprises a valve mount for receiving and holding an inlet valve and a filter mount for receiving and holding a disposable filter element.

### TECHNICAL FIELD The present invention relates to face mask for filtering a respiratory air flow of a user.

### BACKGROUND

Face masks are typically worn by professional workers in, e.g., medical settings, laboratories and construction work for two important reasons. First, to protect the wearer from inhaling a variety of contaminants, from particulates and chemicals to organic bacteria and viruses. And second, to protect others or nearby objects from being contaminated via the breath exhaled by the user. In recent years, many people have started to wear face mask in crowded and public places to in order to reduce the human to human transmission of various contagious diseases.

Face masks come in many different types. The simplest masks just cover the user's mouth with some suitable breathable fabric in order to reduce the number of particles and water droplets being directly inhaled by the user or transmitted to nearby people. More professional face masks include filters for filtering all air inhaled by the user. An at least substantially airtight seal may be provided between the user's face and the mask to ensure that all inhaled air enters the mask via the filter. In situations where the environment is to be protected against bacteria and viruses exhaled by the user, a filter may be provided for the exhaled breath too.

The increased use of face masks has, unfortunately, led to a lot of additional pollution too. Millions around the world buy disposable fabric masks in multi-packs, throwing away the entire mask in favour of a fresh one every day. For some situations this complete disposability is a quick way of assuring zero transmission via the mask, but in general this is a massively un-ecological solution, putting massive quantities of mixed synthetic fibres into the waste stream. The pollution problem may even be aggravated when the disposable masks include filters. Reusable air filtering face masks do exist but tend to be expensive, bulky and heavy.

Many face masks are worn by people who are more vulnerable most vulnerable to infectious diseases and other transmitted health threats, such as the elderly and people with compromised immune systems or other underlying health conditions. Many of the elderly are more difficult to communicate with through deafness or impaired awareness, so a mask which hides the mouth from view takes away the possibility of full or partial lip-reading. Because of this a difficult job of caring for and reassuring such patients, becomes more difficult and riskier if the mask is discarded to communicate more effectively. Furthermore, much of the rest of the population communicates with the help of lip-reading too, especially in the crowded and noisy settings where the use of a face mask would be most beneficial. So here too, there would be an advantage in being able to see a masked persons mouth.

It is an aim of the present invention to address one or more disadvantages associated with the prior art.

### SUMMARY OF THE INVENTION

According to an aspect of the invention there is provided a face mask for filtering a respiratory air flow of a user, the face mask comprising a main body, an external support frame and at least one inlet connector. The main body comprises elastomeric material and is configured to accommodate to facial features of the user. The main body further comprises at least one air inlet opening and at least one air outlet opening. The external support frame supports the main body. The inlet connector extends at least partly through the at least one air inlet of the main body and a corresponding air inlet of the support frame and comprises a valve mount for receiving and holding an inlet valve and a filter mount for receiving and holding a disposable filter element.

The thus obtained face mask provides a lot of advantages over other face masks with air filtering capabilities. The lightweight support frame can be combined with main bodies of different sizes, thereby promoting a good fit for people with differently sized and/or shaped faces. The elastomeric material in the main body further contributes to the mask's ability to accommodate a wide range of face shapes. The main body and the support frame can be made of lightweight and washable materials, which makes most of the face mask reusable.

Only the filter elements that are mountable to the filter mount need to be replaced. The multifunctional inlet connector, by extending through the inlet openings of the support frame and of the main body, connects the two together and prevents relative movement therebetween during use of the face mask. Removal of the disposable filter from the filter mount decouples the main body from the support frame, allowing the user to wash both thoroughly before joining them together and connecting a fresh filter.

An important aspect of the invention is that, due to the provision of an inlet valve in the inlet connector, separate airways are provided for the incoming and outgoing airflows. The filter element at the inlet connector only filters the incoming air. The outgoing air leaves the face mask via a different route, either filtered or unfiltered.

In a preferred embodiment, the face mask further comprises at least one outlet connector at least partly extending through the at least one air outlet of the main body and a corresponding air outlet of the support frame, the outlet connector comprising a valve mount for receiving and holding an outlet valve and a filter mount for receiving and holding a disposable filter element. This embodiment brings the advantage that, in addition to the inhaled air, also the exhaled air is filtered. However, in situations wherein filtering of the exhaled air is not considered necessary, the face mask can be used without a filter connected to the outlet connector, thereby reducing the use of filter material, lowering costs and avoiding unnecessary waste. Since the outlet valve is installed in a separate valve mount, removal of the filter element does not affect the working of the outlet valve and the face mask remains fully functional.

If the filter mount of the inlet connector and the filter mount of the outlet connector are configured to receive and hold identical disposable filters, the same disposable filters can be interchangeably used for both connectors. This will simplify the assembly and reassembly of the face mask and dispense with the need to keep two different types of filter in stock. The inlet connector and the outlet connector may further be configured to comprise an inlet valve as well as an outlet valve. This would make it possible to reverse the direction of the airflow through the respective connectors by just replacing its valve. It would further allow to use identical connectors for the inlet and the outlet.

In a preferred embodiment, the main body further comprises a supplementary opening and the support frame comprises a corresponding supplementary opening. A removable stop member is received in and closing off the supplementary opening of the support frame. With the stop member inserted, the face mask operates as described before. With the stop removed, however, a multifunctional opening appears that can be utilised in various ways in accordance with the needs and preferences of the user. For example, the supplementary opening of the support frame is configured for receiving and holding an outlet valve, an inlet connector and/or an outlet connector. When the supplementary opening of the support frame comprises an outlet valve, this allows the user to swap the outlet connector for an inlet connector. The resulting face mask will have two filtered air inlets, making it easier for the user to inhale large volumes of air. Air is then exhaled through the outlet valve in the supplementary opening. The outlet valve may either be permanently installed behind the removable stop member and activated by removing the stop member, or it may be installed only after the removal of the stop member.

In an embodiment, the filter mount comprises a bayonet mount for connecting to a complementary bayonet ring of the filter element. Such a bayonet fitting allows for easy installation and removal of the disposable filters. It further provides for a tight fit, thereby effectively ensuring an airtight connection between the support frame and the main body and contributing to the sealing function of the face mask.

The filter mount may comprise at least one protrusion, configured to prevent the filter element from contracting due to an inhalation of the user. The protrusion may be part of the aforementioned bayonet fitting. This is especially useful for the filter mount of the inlet connector. Without such protrusions, a pressure drop caused by the user's inhalation may cause the filter to contract and restrict the airflow through the filter. The added protrusions of the filter mount are thus provided for avoiding such contraction. Although such a pressure drop will not affect the volume of an outlet filter, it may still be useful to have such protrusions in the filter mount of the outlet connector too.

In preferred embodiments, the main body comprises a central clear area for, in use, keeping a mouth of the user at least partially visible. The support frame comprises a central aperture for receiving and exposing the central clear area. Keeping the user's mouth visible when wearing the face mask will significantly improve the possibility to communicate with others, thereby reducing the risk that the user will take off the face mask in situations where this would not be desirable.

The support frame may further comprise at least two anchor points configured for connection of a head strap to the support frame. The head strap is preferably adjustable in length, such that a good and substantially airtight fit can be achieved for every user. Optionally, the support frame further comprises a visor mount for holding a removable splash visor. Splash visors can further add to the protection of the user against unwanted contamination.

### BRIEF DESCRIPTION OF THE DRAWINGS

Embodiments of the invention will now be described by way of example with reference to the accompanying drawings, in which:

FIG. 1 shows a front view of a user wearing a face mask according to the invention.

FIG. 2 shows a side view of the user wearing the face mask shown in FIG. 1.

FIG. 3 shows a perspective view of the user using the face mask with a splash visor.

FIG. 4 shows an exploded view of the face mask of FIG. 3.

FIGS. 5a and 5b illustrate two different modes of use for the face mask of FIG. 1.

FIG. 6 shows the main body of the face mask of FIG. 1 in more detail.

FIG. 7 shows the support frame of the face mask of FIG. 1 in more detail.

FIG. 8 shows the filter elements of the face mask of FIG. 1 in more detail.

FIG. 9 shows the inlet connector of the face mask of FIG. 1 in more detail.

FIG. 10 shows the outlet connector of the face mask of FIG. 1 in more detail.

### DETAILED DESCRIPTION

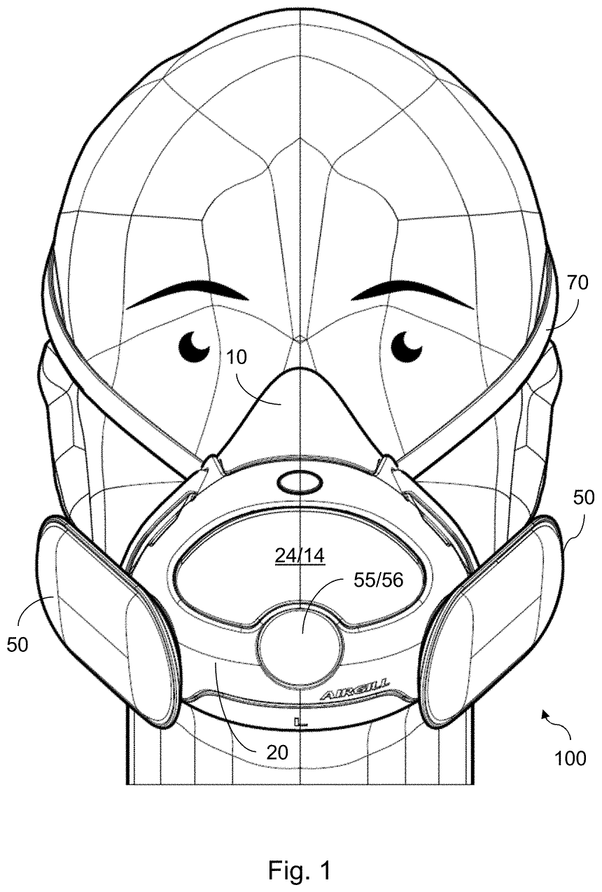

FIG. 1 shows a front view of a user wearing a face mask 100 according to the invention. The face mask 100 comprises a main body 10 that is made from silicon rubber or a similar elastomeric material. The use of an elastomeric material ensures a good and substantially airtight fit of the face mask 100 on the user's face. Deformable zones, e.g. around the nose and mouth of the user, help to accommodate a wide range of face shapes. The main body may be provided in several sizes to further improve the fit. Preferably, the material used for the main body 10 is clear, at least in the area around the user's mouth, in order to make it possible for others to observe mouth and lip movements when the user is speaking.

The flexible and deformable main body 10 is held in position by a more rigid support frame 20 that is held in place by a head strap 70. The support frame 20 may, e.g., be made of plastic. For the head strap 70, silicon or other thermoplastic rubbers may be suitable materials, but less elastic fabrics could also be used. A central aperture 24 in the support frame 20 reveals the user's mouth behind the central clear area 14 of the main body 10.

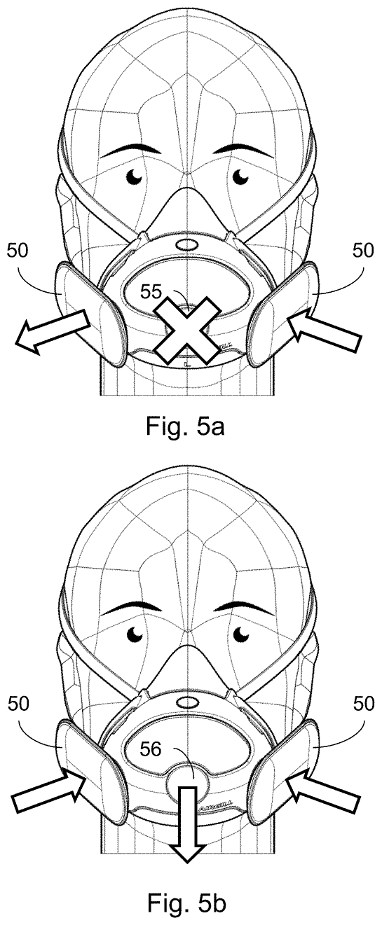

Two filters 50 are attached to the support frame 20 in a way that will be described in more detail below, with reference to some of the other figures. One filter 50 filters the incoming, inhaled air. The other filter filters the outgoing, exhaled air 50. With the face mask 100 according to the invention, it may be possible for the user to choose which one of the two filters 50 functions as the inlet filter and which one as the outlet filter. A supplementary opening in the support frame 10 is closed off by a stop member 55 or occupied by an outlet valve 56, the function of which will be explained below with reference to FIGS. 5a and 5b.

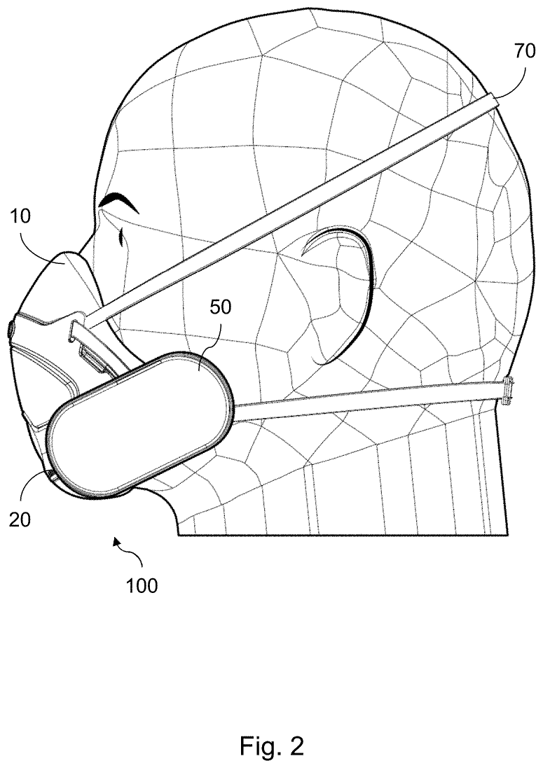

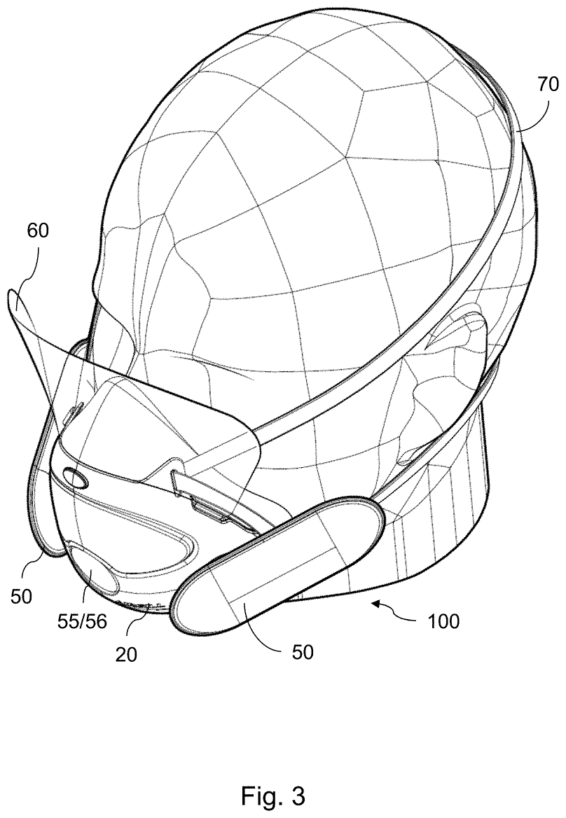

FIG. 2 and FIG. 3 respectively show a side view and a perspective view of the user wearing the face mask shown in FIG. 1. In FIG. 3, an optional and removable splash visor 60 is attached to the face mask 100. The splash visor 60 may protect the user's eyes against, e.g. dust particles or water droplets containing bacterial or viral contaminants. The splash visor 60 may, e.g., be die-cut from some flat and flexible clear plastic film.

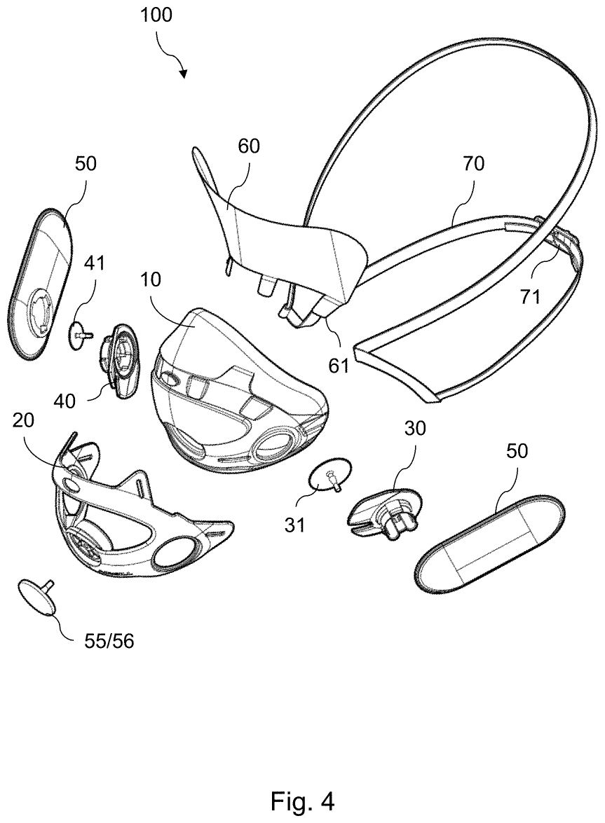

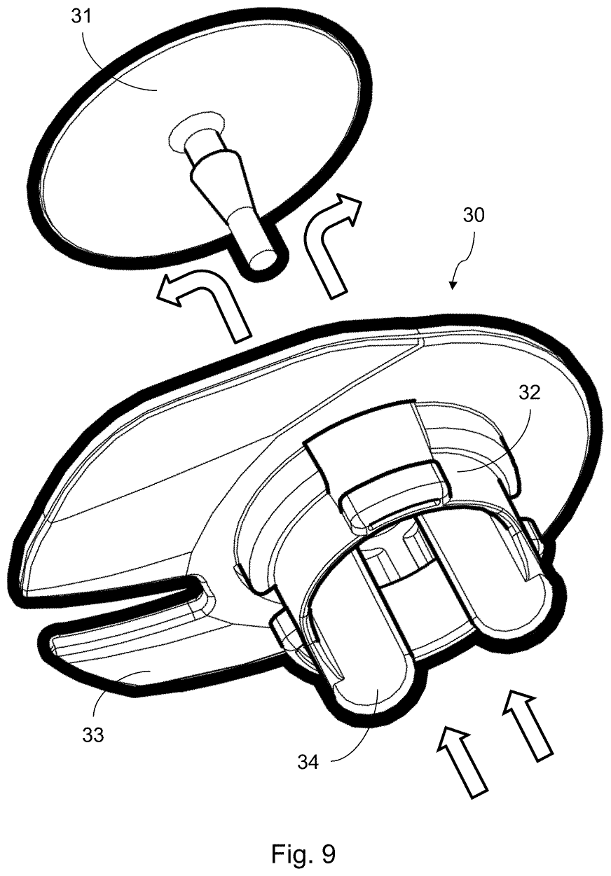

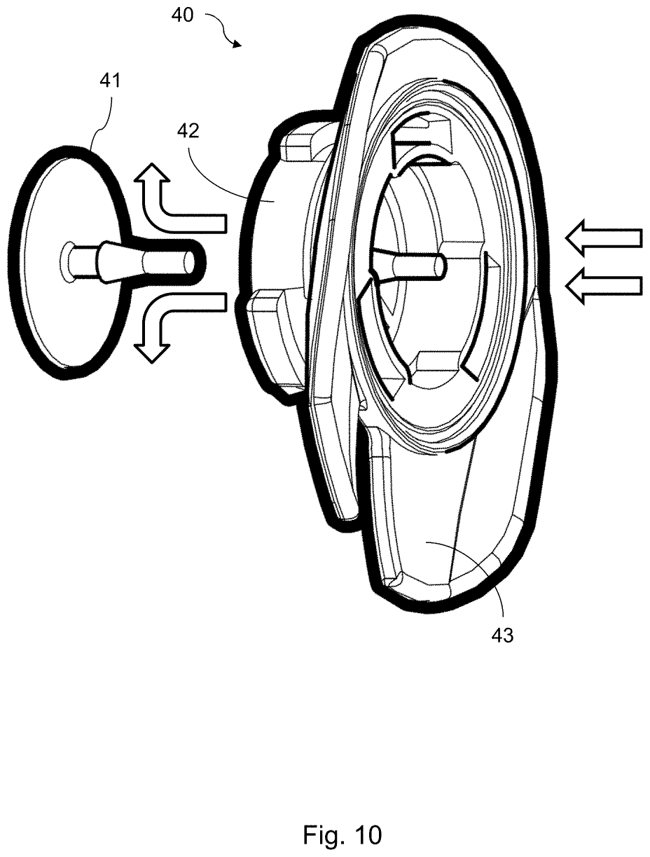

FIG. 4 shows an exploded view of the face mask 100 of FIG. 3. In addition to the features already shown in FIGS. 1 to 3, this figure also shows a buckle 71 for adjusting the length of the head strap 70 and tab members 61 of the splash visor 60 that are configured for being clamped between the main body 10 and support frame 20 to hold the splash visor 60 in place. In addition thereto, FIG. 4 shows an inlet connector 30 and an outlet connector 40. Both connectors 30, 40 fulfil a number of different functions. They house a valve 31, 41 that ensures that air can only flow through the connector 30, 41 in one direction, into the face mask 100 for the inlet connector and out of the face mask 100 for the outlet connector 40. Further, the connectors 30, 40 serve as mounting points for the disposable filter elements 50. Another important function of the connectors 30, 40 is to couple the main body 10 to the support frame 20. In an assembled face mask 100, the connectors 30, 40 extend completely through an opening of the support frame 20 and at least partially through a corresponding opening in the main body 10 in such a way that the main body 10 and the support frame are clamped between a back portion of the connector 30, 40 and the filter element 50. In FIGS. 9 and 10, the connectors 30, 40 are shown in more detail.

FIGS. 5a and 5b illustrate two different modes of use for the face mask 100 of FIG. 1. A key advantage of the face mask 100 described herein is that it can be used in various modes. In FIG. 5a, the left (for the user) filter unit 50 is mounted to an inlet connector 30 (see FIGS. 4 and 9) and filters the incoming air before it is inhaled by the user. When the user exhales, the right filter unit 50, which is connected to an outlet connector (see FIGS. 4 and 10), filters the outgoing air. A supplementary opening in the support frame 20 and a corresponding supplementary opening in the main body 10 are closed off by a stop member 55. Because of the tight fit of the main body 10 to the user's face, the only route for respiratory air streams through the face mask 100 is in via the left filter 50 and out via the right one.

In FIG. 5b, the face mask 100 is used in a different configuration. Only the incoming air is filtered, and the exhaled air is released into the environment without any filtering. Compared to the configuration of FIG. 5a, the outlet connector 40 at the right side of the face mask 100 is replaced by a second inlet connector 30. This widens the airways used for inhalation and allows the user to inhale larger volumes of air more easily. This may, e.g., be useful when the face mask 100 is used for protecting the user against dust and other particulate matter at a construction site where the user may be more physically active and contamination of other people is less of a concern. The stop member 55 is removed from the supplementary opening of the support frame 20 and replaced by an outlet valve 56. This allows the user to exhale through the supplementary opening.

The configurations shown in FIGS. 5a and 5b are just two of the many different possibilities provided by this new adaptable face mask 100. If the supplementary opening is configured for receiving an inlet and/or outlet connector, it may also be used for filtering incoming or outgoing air, possibly with a slightly smaller filter element in order to not obscure the user's mouth. As explained before, the airflow direction in the face mask 100 may be changed by swapping the inlet and outlet connectors. Patients with highly contagious diseases may even inhale unfiltered air through an inlet valve while exhaling through one or more outlet filters.

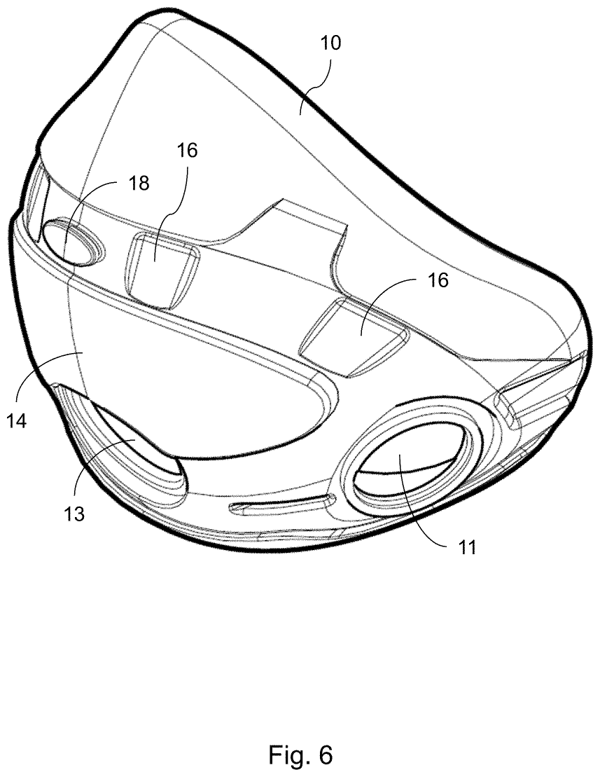

FIG. 6 shows the main body 10 of the face mask 100 of FIG. 1 in more detail. In addition to what has already been shown before, this Figure shows the inlet opening 11 and the supplementary opening 13 of the main body 10. Visor mounts 16 are provided for receiving the tab members 61 of the splash visor 62. The tab members 61 may simply be squeezed between these mounts 16 and a surface of the support frame 20. Alternatively, mounts 16 are provided as slits that can receive and clamp the tab members 61 and the support frame 20 only provides some optional and additional clamping force when the face mask 100 is worn by the user. In yet further alternative configurations, the splash visor 60 may be mounted to the support frame 20 only and not to the main body 10. The central clear area 14 of the main body 10 makes the user's mouth visible during use. In this example, the central clear area 14 is slightly raised above the surrounding portions of the main body 14, to facilitate a correct alignment of the support frame 20 relative to the main body 10. For the same reason, a raised alignment protrusion 18 is provided just above the central clear area 14.

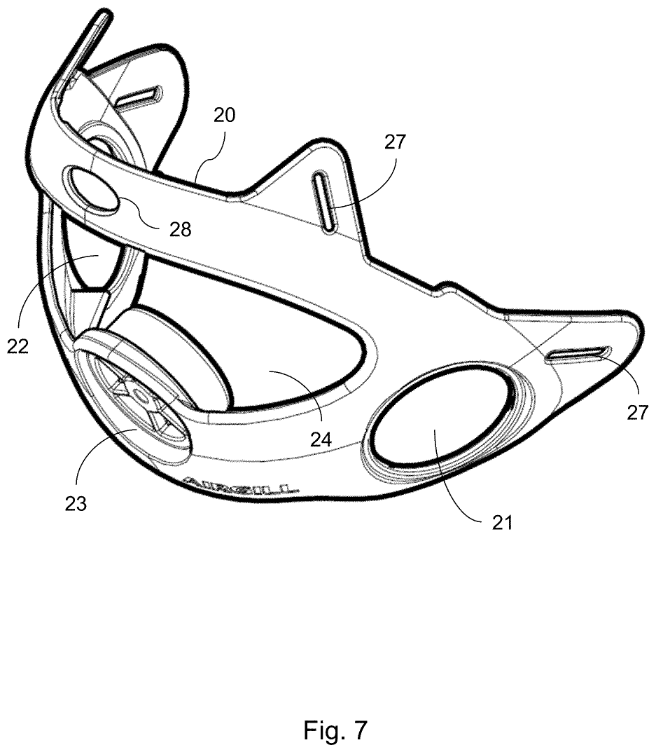

FIG. 7 shows the support frame 20 of the face mask 100 of FIG. 1 in more detail. In addition to what has already been shown above, this Figure shows some anchor points 27 for the head strap 70, the inlet opening 21, the outlet opening 22 and the supplementary opening 23. An alignment aperture 28 is provided just above the central aperture 24 and configured to receive the alignment protrusion 18 of the main body. The supplementary opening is configured for receiving the stop member 55 or an outlet valve 56, depending on which face mask configuration is preferred. In alternative embodiments, the supplementary opening may permanently house an outlet valve, which can be blocked temporarily by a removable stop member 55.

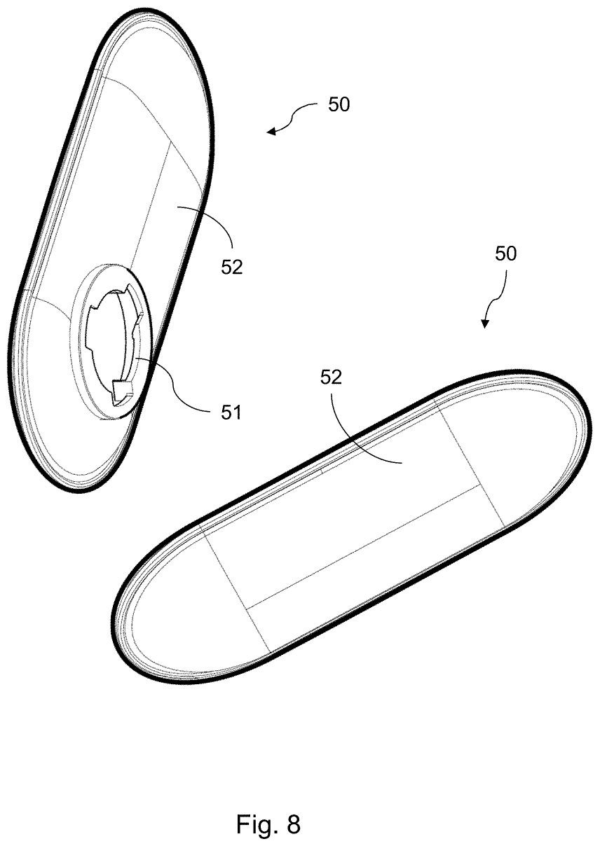

FIG. 8 shows the filter elements 50 of the face mask 100 of FIG. 1 in more detail. Both filter elements 50 are removable and fitted to their respective connectors 30, 40 with rotational bayonet clips. It is noted that, of course, alternative mounting mechanisms may be used for attaching the filter elements 50 to their connectors. In this particular embodiment, the filter elements 50 for the inlet is identical to the filter element 50 for the outlet, which makes all filter elements usable in all the different possible configurations of the face mask 100. The filter elements 50, may be cut from sheet filter material 52 and heat welded around the edges and onto a plastic bayonet union ring 51. The filter material 52 is preferably some kind of N95 grade filter material or other material of similar or higher filtering quality. The bayonet union rings 51 are designed to be fitted to complementary bayonet fittings on the connectors 30, 40. The disposable filter elements 50 are made as small as possible to minimise their effect on the environment, while the mask assembly can be washed and re-used hundreds of times.

FIG. 9 shows the inlet connector 30 of the face mask of FIG. 1 in more detail. The inlet connector 30 comprises a bayonet fitting 32 that protrudes from a connector base 33. When the face mask 100 is assembled, the bayonet fitting 32 sticks through the inlet opening 21 of the main body 10 and the inlet opening of the support frame 20, while the connector base 33 rest against the inside surface of the main body 10. In an alternative embodiment, the connector base 33 may fit into a slot provided between an inner and an outer surface of the main body 10. In such an embodiment, the bayonet fitting 32 will only partly extend through the main body 10.

An inlet valve 31 is inserted into the connector 30. When the user inhales, the inlet valve 31 is pulled inward by the reduced air pressure inside the main body 10, and air flows through the inlet connector 30 into the main body 10 and into the user's lungs. When the user exhales, the inlet valve 31 is pushed outward by the increased air pressure inside the main body 10 and thereby blocks any airflow through the inlet connector 30. A filter element 50 as shown in FIG. 8 is connected to the bayonet fitting 32. Two protrusions 34 protruding from the bayonet fitting 32 make sure that the two opposing filter surfaces 52 of the filter element 50 remain separated during the inhalation, thereby keeping the inlet airway fully opened.

FIG. 10 shows the outlet connector 40 of the face mask 100 of FIG. 1 in more detail. It is very similar in setup and construction to the inlet connector 30 of FIG. 9. One difference is that it has an outlet valve 41 instead of an inlet valve. During exhalation, the outlet valve 41 is pushed outward and the user's breath can leave the outlet connector 40 through the filter element 50 that is connected to the bayonet fitting 42. This bayonet fitting 42 does not have any protrusions, because the outlet connector 40 does not run the risk of being contracted and restricting the airways because of the user's respiration.

In a different embodiment, the inlet connector and the outlet connector may have identical designs. In that case, both should be designed to accommodate an inlet valve 31 when used for filtering incoming air and an outlet valve 41 when filtering outgoing air. Also, both connectors may have the protrusions 34 extending from the bayonet fitting 32 in order to prevent contraction of the filter element 50 when used as in inlet connector.

1. A face mask for filtering a respiratory air flow of a user, the face mask comprising:
a main body comprising elastomeric material and configured to accommodate to facial features of the user, the main body including at least one air inlet opening and at least one air outlet opening;
an external support frame for supporting the main body; and
at least one inlet connector at least partly extending through the at least one air inlet of the main body and a corresponding air inlet of the external support frame, the inlet connector including a valve mount for receiving and holding an inlet valve and a filter mount for receiving and holding a disposable filter element.

2. A face mask as claimed in claim 1, further comprising at least one outlet connector at least partly extending through the at least one air outlet of the main body and a corresponding air outlet of the external support frame, the outlet connector including a valve mount for receiving and holding an outlet valve and a filter mount for receiving and holding a disposable filter element.

3. A face mask as claimed in claim 2, wherein the filter mount of the inlet connector and the filter mount of the outlet connector are each configured to receive and hold identical disposable filters.

4. A face mask as claimed in claim 2, wherein the valve mount of the inlet connector and the valve mount of the outlet connector are each configured to receive and hold an inlet valve and an outlet valve.

5. A face mask as claimed in claim 2, wherein the main body includes a supplementary opening, and wherein the external support frame includes a corresponding supplementary opening and a removable stop member received in and closing off the supplementary opening of the external support frame.

6. A face mask as claimed in claim 5, wherein the supplementary opening of the external support frame is configured for receiving and holding an outlet valve, and one or both of an inlet connector and an outlet connector.

7. A face mask as claimed in claim 6, wherein the supplementary opening of the external support frame comprises an outlet valve.

8. A face mask as claimed in claim 1, wherein the filter mount comprises a bayonet mount for connecting to a complementary bayonet ring of the filter element.

9. A face mask as claimed in claim 1, wherein the filter mount includes at least one protrusion configured to prevent the filter element from contracting due to an inhalation of the user.

10. A face mask as claimed in claim 1, wherein the main body includes a central clear area for, in use, keeping a mouth of the user at least partially visible, the external support frame including a central aperture for receiving and exposing the central clear area.

11. A face mask as claimed in claim 1, wherein the filter element is mounted to the filter mount and wherein the filter element comprises an N95 fabric.

12. A face mask as claimed in claim 1, wherein the elastomeric material comprises silicone.

13. A face mask as claimed in claim 1, wherein the external support frame is made of a plastic.

14. A face mask as claimed in claim 1, wherein the external support frame further includes at least two anchor points configured for connection of a head strap to the support frame.

15. A face mask as claimed in claim 1, wherein the external support frame further includes a visor mount for holding a removable splash visor.
